(19) United States
(12) Patent Application Publication
(10) Pub. No.: US 2017/0132675 A1
(43) Pub. Date: May 11, 2017

(54) SYSTEMS AND METHODS FOR RATING TRUCKERS AND CUSTOMERS

(71) Applicant: Charles F. Myers, Midlothian, VA (US)

(72) Inventor: Charles F. Myers, Midlothian, VA (US)

(21) Appl. No.: 14/937,826

(22) Filed: Nov. 10, 2015

(51) Int. Cl. G06Q 30/02; G06Q 10/08

(52) U.S. Cl. CPC G06Q 30/0282; G06Q 10/0834

(57) ABSTRACT

Systems and methods are disclosed to allow truckers and shippers to rate each other in an on-line trucker board portal.

### BACKGROUND

The present application is related to systems and methods for rating trucking services.

One of the greatest challenges for new owner-operators and small fleet owners is finding loads. This task can be difficult and represents one of the most common reasons why many small trucking companies go out of business. Load boards also have some disadvantages. For starters, competition for good loads and popular routes is fierce. This competitive environment means that truckers have to price trucking services low to attract customers. However, the trucker only pulls one load for a shipper and then he/she is done and must return to the load board to find the next load. And the trucker needs to fight for every load after that one job. Thus, the trucker cannot grow a profitable trucking company with load boards, especially when competing on price alone. Correspondingly, for brokers and shippers, looking for loads at low prices is not the best way. For example, brokers looking for the cheapest source of truckers can get burned when the deliveries are late or damaged by careless truckers.

### SUMMARY

Systems and methods are disclosed to allow truckers and shippers to rate each other in an on-line trucker board portal.

In one aspect, systems and methods are disclosed for a processor-implemented feedback collection module configured to: match a shipper with a trucker to transport a load in a shipping transaction; and request rating information from the shipper relating to the shipping transaction, the requested rating information relating to performance of the trucker with respect to the transaction in a plurality of performance categories, wherein the rating information includes shipping quality, shipping cost, timely arrival, condition of delivered items, payment promptness; and a score generator configured to generate a performance score relating to the trucker using the rating information.

Implementations of the system and method may include one or more of the following. The method can automatically discover new loads or points of interest in proximity to the truck driver device based on a detected change in the geographical location of the truck driver device and based on a shipper with at least a predetermined rating information from other truckers. The method can update a database that includes a load category of interest, a shipper with at least a predetermined rating information from other truckers, and a location of interest. The method can also upload a geographical location of the trucker. The method can also select a trucker or a shipper within a predetermined range of the geographical location having at least a predetermined rating. The method can also decrease a trucker's feedback score if the trucker receives more negatives than positives from one shipper in the same week. The method can also increase a trucker's feedback score if the trucker receives more positives than negatives from one shipper in the same week. If a trucker receives the same number of negatives and positives from the same shipper or broker in the same week, the score is unchanged. The method can also increase a shipper's feedback score for each shipment. The method can also include tracking geographical location of the trucker relative to a point of interest for each truck load; matching the geographical location of the device to a category of interest associated with the trucker and shipper with at least a predetermined rating information from other truckers; sending a notification to the device of a nearby position of the load, the nearby position of the load related to the category of interest, the notification sent in response to proximity of the geographical location of the device relative to the position of the load; and utilizing a processor that executes instructions stored in memory to perform at least one of the acts of tracking, matching, or sending. The method can also select a set of questions, to be presented to the first user in order to request the rating information, based on an amount of the performance data retrieved from a rating database. The method can also elect a set of questions, to be presented to a user in order to request the rating information, based on transaction data pertaining to the transaction. The method can also select a set of questions, to be presented to the user in order to request the rating information, based on an item type of a subject item of the transaction. The method can also request generic rating information related to the transaction. The method can also request specific rating information related the plurality of performance categories. The method can also collect performance information retrieved from a rating database for each shipping transaction of the plurality of shipping transactions, wherein an associated rating and performance data for each transaction of the plurality of transactions being identified as one of a subjective criteria and an objective criteria; and code to generate a quality score to generate a performance quality score for the trucker using the associated rating and performance information, the performance quality score being lowered if a number of negative ratings associated with the plurality of transactions are below a predetermined threshold. The method can also collect performance information retrieved from a rating database for each shipping transaction of the plurality of shipping transactions, wherein an associated rating and performance data for each transaction of the plurality of transactions being identified as one of a subjective criteria and an objective criteria; and code to generate a quality score to generate a performance quality score for the shipper using the associated rating and performance information, the performance quality score being lowered if a number of negative ratings associated with the plurality of transactions are below a predetermined threshold. The method can also adjust the performance score using the performance quality score. The method can also generate a transaction performance score using the rating information.

In another aspect, the method for shipping items includes matching a shipper with a trucker to transport a load in a shipping transaction; and collecting rating information from the shipper relating to the shipping transaction, the requested rating information relating to performance of the trucker with respect to the transaction in a plurality of performance categories, wherein the rating information includes shipping quality, shipping cost, timely arrival, condition of delivered items, payment promptness; and deriving a performance score relating to the trucker using the rating information.

The method includes automatically discovering new loads or points of interest in proximity to the truck driver device based on a detected change in the geographical location of a truck driver device, wherein each load or points of interest is associated with a shipper with at least a predetermined rating information from other truckers. The method can also include automatically discovering truckers in proximity to a load based on a detected change in the geographical location of a truck driver device, wherein each trucker meets at least a predetermined rating information from other shippers.

Advantages of the system may include one or more of the following. The system helps truckers find perfect client ahead of time. Truckers can build loyalty with large shipper or freight brokerage who pays well and who needs services regularly. The rating system allows truckers and shippers to operate on the basis of quality and service rather than being completely focused on getting the cheapest rate all the time.

### BRIEF DESCRIPTION OF THE DRAWINGS

FIG. 1A is an exemplary shipping service transaction processing system for shippers/brokers and truckers.

FIG. 1B shows more details of the network-based trucking marketplace.

FIG. 2 shows an exemplary process for dynamic load discovery and matching of truckers and shippers.

FIG. 3 illustrates a method for inputting and calculating transaction performance ratings.

FIG. 4A-4C show exemplary user interfaces of the Trucker Path app for trucker.

### DETAILED DESCRIPTION

A method and apparatus for providing and displaying enhanced feedback in an on-line trucking software as a service (SaaS) environment are described. In the following description, for purposes of explanation, numerous specific details are set forth in order to provide a thorough understanding of the present invention. It will be evident, however, to one skilled in the art that the present invention may be practiced without these specific details.

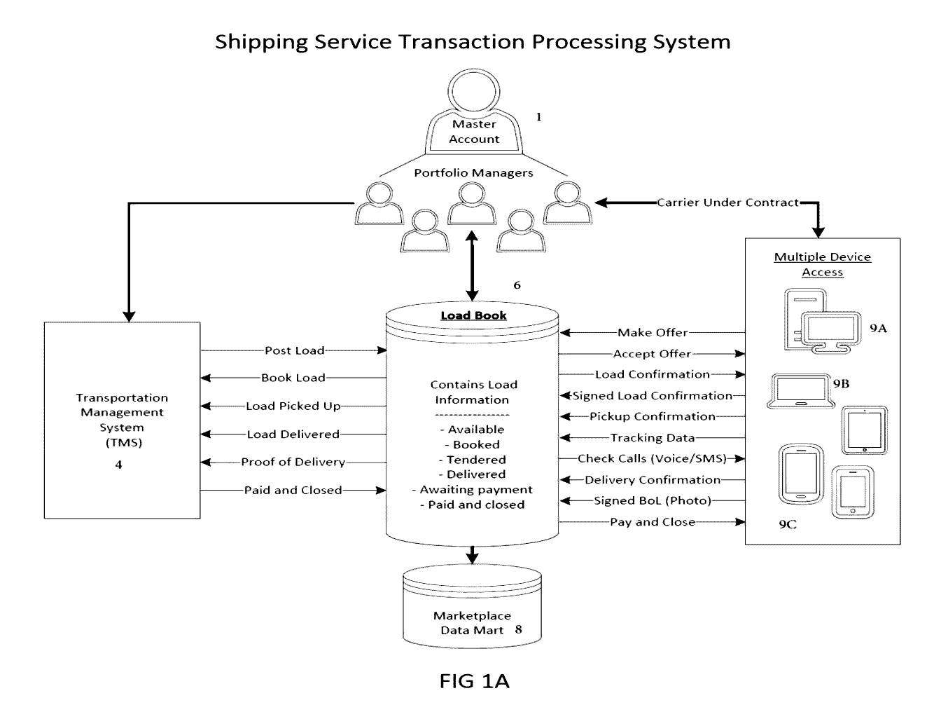

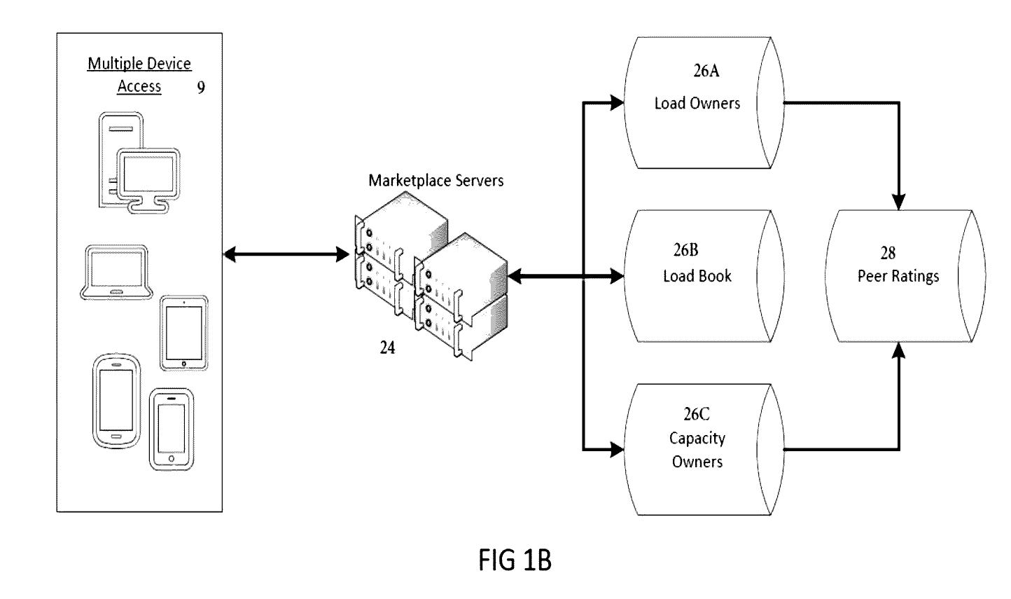

FIG. 1A is an exemplary shipping service transaction processing system for shippers/brokers and truckers. According to one exemplary embodiment, the shippers/brokers can have a master account 1 with a plurality of portfolio managers communicating with truckers/carriers using a client-server architecture that includes a load book 6. The portfolio managers can communicate through a transportation management system (TMS) 4 the communicates with the load book 6 information such as load posting, load booking, load pickup and delivery information, payment information, and case closing operations. The trucking commerce platform, in the exemplary form of a network-based marketplace supported by data mart 8, provides server-side functionality, via a network (e.g., the Internet) to one or more clients. FIG. 1A illustrates, for example, a web client and a programmatic client executing on respective client machines 9A, laptops 9B and mobile devices 9C. The client machine can be a desktop computer for brokers and customers, or can be laptops or mobile phones for truckers. The truckers or carriers can make/accept offer, confirm load pick up, send tracking data, check for calls, provide delivery confirmation, and acknowledge payment and contract closure, among others.

FIG. 1B shows more details of the network-based trucking marketplace, where a marketplace server 24 is coupled to, and provides programmatic and web interfaces respectively to, one or more database (DB) servers including load owner DB 26A, load book DB 26B, capacity owner DB 26C, all of which communicate with a peer rating DB 28.

The marketplace server 24 provides a number of marketplace functions and services to users that access the marketplace 24. The payment applications likewise provide a number of payment services and functions to users. The payment applications may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications. Further, while the trucking service system shown in FIG. 1A-1B employs client-server architecture, the present system is of course not limited to such an architecture, and could equally well find application in a distributed, or peer-to-peer, architecture system. The various marketplace applications could also be implemented as standalone software programs, which do not necessarily have networking capabilities.

The mobile or web client, it will be appreciated, accesses the various shipping service marketplace and payment application via the web interface supported by the web server 26. Similarly, the mobile or web client accesses the various services and functions provided by the marketplace and payment applications such as a trucking application (e.g., the TruckerPath application developed by TruckerPath Inc., of San Jose, Calif.) to enable truckers to author and manage truck service listings on the marketplace in an off-line manner, and to perform batch-mode communications between the programmatic client and the network-based marketplace.

Other third party applications can access the server and may, utilizing information retrieved from the network-based marketplace 8, support one or more features or functions on a website hosted by the third party. The third party website may, for example, provide one or more promotional, marketplace or payment functions that are supported by the relevant applications of the network-based marketplace 8. The network-based marketplace 8 itself, or one or more parties that transact via the marketplace 8 may operate loyalty programs that are supported by one or more loyalty/promotions applications. For example, a shipper or broker may earn loyalty or promotions points for each transaction established and/or concluded with a particular Trucker, and may be offered a reward for which accumulated loyalty points can be redeemed.

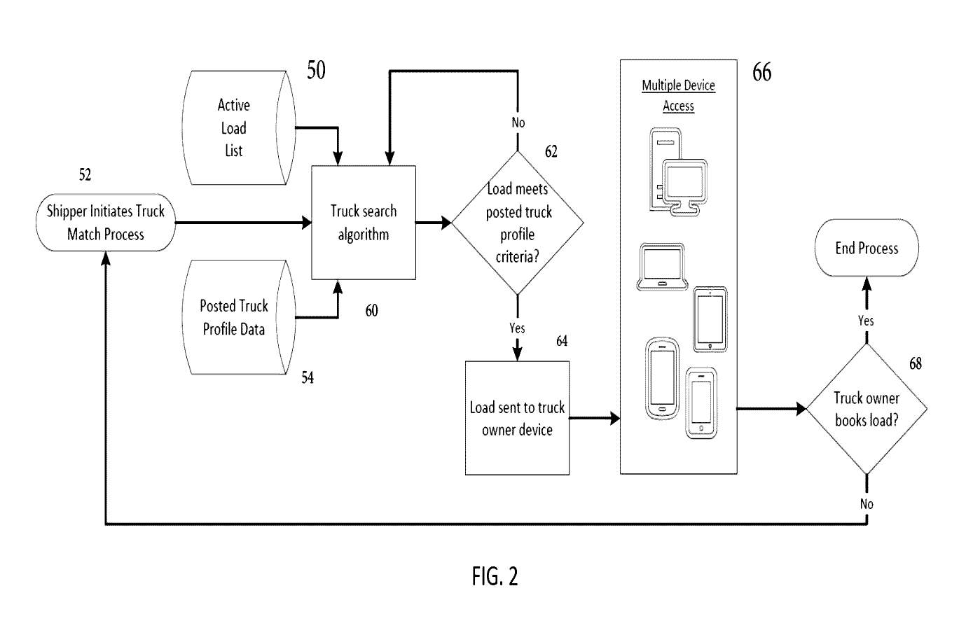

FIG. 2 shows an exemplary process for dynamic load discovery and matching of truckers and shippers. The process provides an active load list 50 into a truck search unit 60. A new truck match request 52 is provided to the load search unit 60, as is truck profile data 54. The load search unit 60 checks if a particular load meets a selected truck profile criteria in 62. If not, the next truck is search by unit 60, and otherwise in 64 the process sends available load lists to multiple device access 66 such as a truck driver's smart phone, for example. The phone checks if the driver has booked the load and does not need additional load searches in 68. If not, the truck profile is updated to indicate that the trucker is still available, and otherwise the process exits.

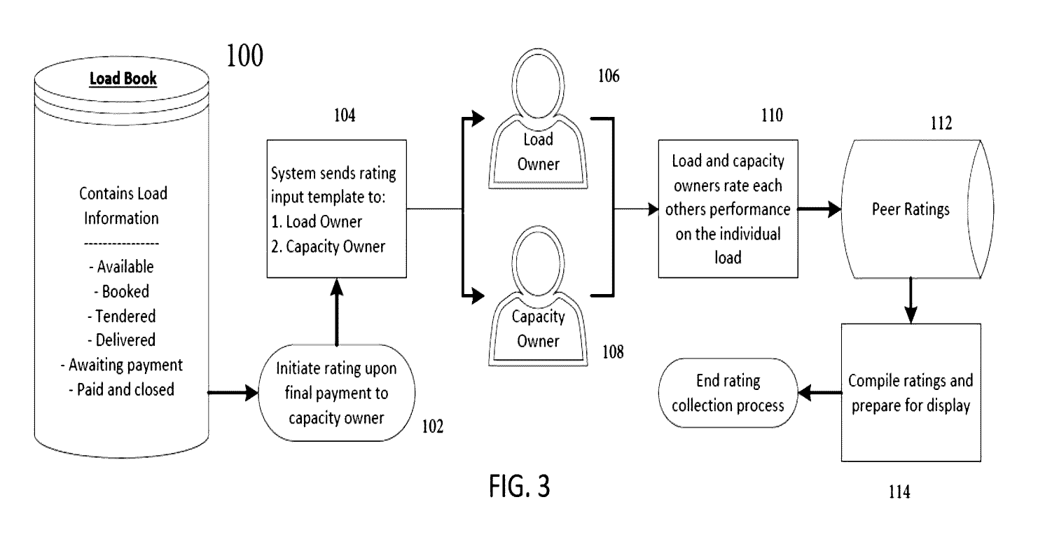

FIG. 3 shows an exemplary system for rating shippers and truckers. The system retrieves data from a load book 100 that contains load information such as availability, booked loads, tendered loads, delivered loads, and payment/closure information, for example. The system initiates a rating request upon payment to the trucker, shipper, or capacity owner in 102. Next, in 104, the rating questionnaire is sent to load owner 106 and the capacity owner 108 to rate each other for a particular transaction. In 110, the load and capacity owners rate each other's performance on the transaction. The information is saved in a peer ratings database 112. The system then compiles ratings and updates a display panel for each party's performance ratings in 114 before exiting the process.

Feedback leaving client 9A, 9B or 9C enables a user who wants to leave feedback to interact with the trucking service system. In one embodiment, the feedback viewing client is a computer system that enables a user who wants to view feedback to interact with the trucking service system. Network is a communications network, such as a LAN, WAN, intranet or the Internet. Trucking service Web site host is a system for hosting an trucking service Web site, such as an online auction or trading Web site. Trucking service Web server is a computer system that provides World Wide Web services, for example, to deliver Web pages using a markup language. Trucking service TruckerPath server is a computer system that provides support for functions as required by trucking service Web site host, such as receiving and processing transaction requests received by trucking service Web site host.

Truckers and customers/brokers who have entered into a transaction can rate each other at the end of the transaction. A Feedback score is then attached to each member profile. One embodiment positions the Feedback score as a number in parentheses next to a member's username, and is also located at the top of the Feedback Profile. Next to the Feedback score, the user or member may also see an icon such as a truck with variation in colors, the brighter the color the higher the rating, for example. The number of positive, negative, and neutral Feedback ratings a member has received over time is part of the Feedback score. For each transaction, truckers and shippers/brokers can choose to rate each other by leaving Feedback. Shippers/Brokers can leave a positive, negative, or a neutral rating, plus a short comment. Truckers can leave a positive rating and a short comment and the system applies the ratings to determine Feedback scores. In most cases, members receive:
+1 point for each positive rating
No points for each neutral rating
−1 point for each negative rating

If the trucker receives more negatives than positives from the same shipper in the same week, the system lowers the shipper's Feedback score by 1 point.

If the shipper receives more positives than negatives from the same shipper in the same week, the system raises the Trucker's Feedback score by 1 point.

If a trucker receives the same number of negatives and positives from the same shipper or broker in the same week, the score is unchanged.

For shippers, the Feedback score is raised by a total of 1 point, regardless of the number of positive ratings received within the week.

Leaving honest comments gives others a good idea of what to expect when dealing with a member. Leaving Feedback is also a way to express appreciation. Finally, a shipper can help spread the word about a trucker he/she likes, and truckers can help recognize and reward loyal customers.

Feedback comments become a permanent part of a trucker's record. If you're a shipper, the comments can relate to timeliness and pricing and quality. Truckers are typically rated in up to 4 more areas: service as described, communication, shipping time, and shipping and handling charges. These ratings don't count toward the truckers' Feedback score.

One implementation of the feedback database structure includes exemplary tables “User Information”, “User Preferences”, “Completed Transactions Between Trucker and Shipper”, “List Of Shipper Questions Based On Item Transaction Category”, “List of Trucker Questions Based On Item Transaction Category”, “Feedback Score”, “Feedback Left Score”, “Feedback Detail History Overall”, and “Feedback Detail History”. In one exemplary embodiment, the “Completed Transactions Between Shipper and Trucker” tables includes comprehensive details of the transaction. Upon completion of a transaction, each party to the transaction (e.g., the shipper or broker and the Trucker) are requested to leave feedback regarding the quality of performance by the opposite party. In one exemplary embodiment of the present invention, the shipper is presented with the list of questions according to the user's status as a shipper. The questions presented may also be generated according to the transaction category. The feedback in the form of an overall performance rating and in the form of responses to individual questions is gathered and stored. The overall performance information is stored in the raw “Feedback Detail History Overall” as an evaluation of the shipper overall experience with respect to the shipping transaction (e.g., positive/negative/neutral/not available). The detailed answers to the questions are stored in the “Feedback Detail History”. These answers may be aggregated and summed into the “Feedback Score” associated with the shipper or broker as well as into the “Feedback Left Score” for easier lookup without extensive calculations. Similarly, the Trucker is presented with the list of questions according to the user's status as a trucker, and the feedback regarding the completed transaction is obtained and processed according to the technique described above. The questions presented may also be generated according a transaction category and may vary based on the information or data automatically collected. For example, if information regarding when payments were made or items shipped was obtained from a payment or shipping partners then a question such as “Was payment timely?” need not be asked.

It will be appreciated that feedback data or information may be sourced from one or more local and/or remote information systems and need not be limited to information that is entered in response to the questions asked of a transacting party (e.g., trucker or shipper). For example, a feedback information could be obtained from local or remote payment applications 32 or a transaction processing facility to find out when a particular transaction was paid. The information may be obtained, for example, by way of a call out. Alternatively, the local or remote payment applications or a transaction processing facility could push this information into the system 10. In one exemplary embodiment, this information may be used to determine how many days or hours after the listing closed that the shipper paid. Accordingly, an average payment time may be displayed as part of the shipper's reputation information.

The TruckerPath Web site host may be configured to enable the user to view reputation information (e.g., feedback) with respect to another user. The user may request to view the reputation information associated with the opposite transacting party. Alternatively, the user may be presented with the relevant reputation information associated with the opposite transacting party responsive to the user's request to enter into a transaction with another user. The overall view may be provided to the user according to the requesting user's preferences stored in “User Preferences”. A view of associated reputation information is then retrieved from the feedback score table stored in “Feedback Score” and the feedback left score table stored in “Feedback Left Score”. If the user desires details, then the details may be presented (e.g., in paginated format) utilizing “Feedback Detail History Overall” and “Feedback Detail History”. The user may be enabled selectively to access reputation information according to criteria such as promptness of payment information, quality of performance information, timeliness of performance information, or promptness of response information as well as according to other criteria. Other criteria may be, but not limited to, shipping, packaging, item accurately described, promptness of leaving feedback, was the item returned by the shipper, was there a non-payment, when was the item received, etc.

FIG. 3 provides a method of inputting and calculating transaction performance ratings. According to one exemplary embodiment, the user, via feedback leaving client 9A-9C, selects one or more transactions from a shipping transaction list and presents a feedback rating form for the particular transaction. The feedback rating form presents feedback rating questions to the user grouped according to performance categories and varying based on the transaction data or information automatically collected by the system. That is, the user may, for example, be presented with three questions regarding shipping and handling, two questions regarding the accuracy of the item description, and four questions regarding how quickly the Trucker responded to communications. The form may also provide a comment field that enables the shipper or broker to enter a customized message regarding the Trucker or choose a message from a list of prepared messages.

The system can prompt the user to answer questions. For example, the user via feedback leaving client answers the questions posed on the feedback rating form. The user's answers to feedback rating questions may take the form of subjective answers such as positive, negative, neutral, not applicable. Examples of methods the user might use to select the appropriate answer include (1) entering a number that corresponds to the appropriate answer; (2) choosing a radio button that corresponds to the appropriate answer; and (3) choosing the appropriate answer from a list of available answers. In instances where a feedback rating question does not pertain to a particular transaction, the user may answer not applicable. For example, if there were no items returned during a particular transaction, the user would answer not applicable to questions concerning how well the Trucker handled item returns. In one embodiment, in addition to the above subjective answers, the questions may elicit objective answers such as “What date was the item received?” which may be processed to estimate an average shipping time. Other questions that may elicit objective answers include “Did you have a problem with the transaction?”, “Was a return asked for?”, “How many communications did you have with the shipper or broker?”, “What payment method was used?” and so on.

Performance data is collected from one or more local or remote system. Such a system may provide payment applications (e.g., the payment application) may provide objective information or data that is automatically obtained. For example, an actual date of dispatch or payment for a listing may be obtained from third party (e.g., a financial institution, PayPal, or the like). The user submits the completed feedback rating form via feedback leaving client 9A-9C, and the system transmits the raw feedback data to trucking service Web site where the server receives the rating form and stores the feedback rating details in a feedback history table stored in “Feedback Detail History” within a feedback database structure. Feedback rating details include the shipper or broker's identity, the Trucker's identity, the item or service involved in the transaction, and the date of the transaction.

The system then determines Trucker Feedback Scores. In this operation, trucking service TruckerPath server retrieves the Trucker's feedback rating information from “Feedback Detail History” within feedback database structure and calculates Trucker feedback scores based on the feedback ratings provided in operation and feedback information automatically collected from a local or remote system. In particular, trucking service TruckerPath server calculates an aggregate feedback score for the Trucker, as well as a feedback score for individual performance categories (e.g., shipment time, accuracy of description, communication time, etc.). In one exemplary embodiment, performance category scores may be ratings and/or actual data that may be manually or automatically collected, for example, ship time: average of 3.1 days, shipment on time: 99 positive (99%), and so on. The overall feedback score for both shipper or broker and Trucker may be calculated based on total positive feedback, total negative as well as distinct positives and negatives based on distinct users and data collected. The feedback score for detailed performance categories may be calculated based on total positives and total negatives vs. overall totals for that category. The system can store as the “Feedback Score” the rating scores in a feedback rating table, which contains a record for each Trucker, with each record including multiple data fields that contain the Trucker's aggregate and performance category feedback scores.

In one exemplary embodiment, feedback score may be weighed differently for individual performance categories according to the type of a performance category. For example, feedback score associated with the shipment time may be attributed more weight than feedback score associated with the accuracy of description or communication time, and vice versa. In a further exemplary embodiment of the present invention, a feedback viewing user may be presented with a selection of methods to calculate overall feedback score based on the importance the feedback viewing user places on particular types of performance categories. For example, an interface may be provided to the feedback viewing user to allow the feedback viewing user to indicate the order of importance associated with performance categories (e.g., from the most important performance category to the least important performance category). The order of importance associated with performance categories may be utilized to calculate the overall feedback score for the Trucker.

Feedback-left scores are calculated as averages of the number of positive, negative, neutral, or not applicable ratings the shipper or broker has given over the course of time as he/she provides feedback on Truckers. This feedback-left score is used to gauge a shipper or broker's overall mode of feedback, e.g., the shipper or broker's feedback tendency to give high, medium or low feedback scores. Trucker feedback scores may be adjusted according to the shipper or broker's overall feedback mode. While viewing the feedback, the viewer may be able to see the overall tendency of the person leaving feedback, which may be termed as feedback quality information. For example, if a person always leaves negative feedback to everyone, then there could be an unhappy face icon associated with that person in the feedback detail view. To more accurately reflect the shipper or broker's mode of feedback, feedback-left ratings may begin to be calculated after a shipper or broker has provided feedback with respect to a minimum number of transactions.

The trucking service server then calculates an aggregate feedback score for the shipper or broker, as well as a feedback score for individual performance categories (e.g., payment time and communication time). As in the case of the shipper or broker side, performance category scores may be ratings and/or actual data that may be manually or automatically collected, for example, for truckers—delivery on time: 99 positive (99%), or for shippers—paid within 7 days (90%) and so on. The overall feedback score for both shipper or broker and Trucker are calculated based on total positive feedback, total negative as well as distinct positives and negatives based from distinct users. The feedback score for detailed performance categories are calculated based on total positives and total negatives vs. overall totals for that category.

In one exemplary embodiment, feedback score may be weighed differently for individual performance categories according to the type of a performance category. For example, feedback score associated with the payment time may be attributed more weight than feedback score associated with the communication time, and vise versa. In a further exemplary embodiment of the present invention, a feedback viewing user may be presented with a selection of methods to calculate overall feedback score based on the importance the user places on particular types of performance categories. For example, an interface may be provided to the feedback viewing user to allow the feedback viewing user to indicate the order of importance associated with performance categories (e.g., from the most important performance category to the least important performance category). The order of importance associated with performance categories may be utilized by the trucking service system 10 to calculate the overall feedback score for the shipper or broker.

The feedback information may contain responses to detailed and specific questions provided by the trucking service server or automatically collected data. In one exemplary embodiment, the responses to detailed and specific questions may be parsed and grouped according to the predefined performance categories. Such grouping may be utilized for formulating feedback score in relation to a particular aspect of a transaction, in addition to the predefined performance categories, such as “promptness of payment and quality of goods or services”. This information may also be grouped into categories for the purpose of enabling a user to request and view feedback information according to a specific performance category.

In one exemplary embodiment of the present invention, a user may be presented with a selection of one or more specific categories of feedback information (e.g., overall rating of the transaction, promptness of payment by the shipper or broker, promptness of delivery by the Trucker, etc.). If the user selected one or more specific categories of feedback information, the information may be presented to the user according to the selection. The trucking service server may be configured to provide a default display of feedback information if the user does not wish to select a particular category of feedback information. The default display may include, for example, overall satisfaction with the transaction score.

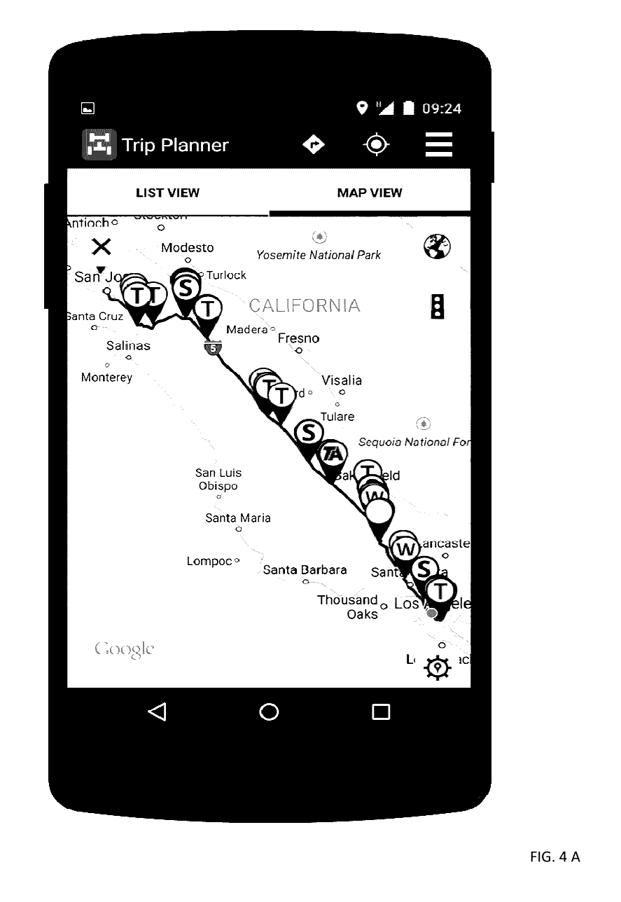

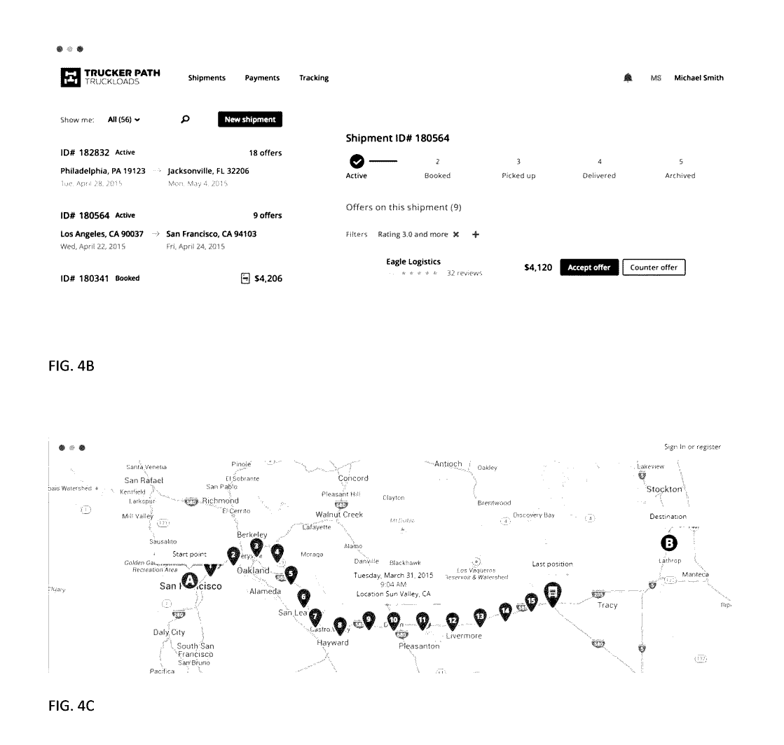

FIG. 4A shows an exemplary user interface of the Trucker Path app for trucker, which shows all major and independent truck stops, truck parking, rest areas, open/closed weigh stations, Walmart stores with truck parking, scales, truck washes, hotels and restaurants nearby. The information is constantly being verified and updated by other Trucker Path users and the team to ensure its accuracy.

FIG. 4B shows an exemplary marketplace where shipper can request bids for shipping services. Upon mutual agreement as to price and delivery terms, the shipper and trucker enter into a binding agreement. As shown in FIG. 4C, integrated in Trucker Path Truckloads—the tracking platform keeps shippers and brokers up to date on shipment location from pickup to delivery. The app helps carriers find nearby loads and connects them with top-rated brokers and shippers.

Although the components of the system are described as individual exemplary modules, the functionality of one or more exemplary modules may be combined in an alternative embodiment of the present invention. For example, the system may be configured such that the functions performed by the feedback quality score generator and the feedback score adjusting module are performed by a single module.

The above system is run by a computer within which a set of instructions (e.g., software) may be executed for causing client computers and server computers mentioned above to perform the methods of the present invention. In alternative embodiments, hard-wired circuitry may be used in place of or in combination with software instructions to implement the invention. Thus, embodiments of the invention are not limited to any specific combination of hardware circuitry and software.

Thus, method and apparatus for providing and displaying enhanced feedback in an online transaction processing environment has been described. Although the present invention has been described with reference to specific exemplary embodiments, it will be evident that various modifications and changes may be made to these embodiments without departing from the broader scope and spirit of the invention. Accordingly, the specification and drawings are to be regarded in an illustrative rather than a restrictive sense.

What is claimed is:

1. A system, comprising:
a processor-implemented feedback collection module configured to:
match a shipper with a trucker to transport a load in a shipping transaction; and
request rating information from the shipper relating to the shipping transaction, the requested rating information relating to performance of the trucker with respect to the transaction in a plurality of performance categories, wherein the rating information includes shipping quality, shipping cost, timely arrival, condition of delivered items, payment promptness; and
a score generator configured to generate a performance score relating to the trucker using the rating information.

2. The system of claim 1, comprising code to automatically discover new loads or points of interest in proximity to the truck driver device based on a detected change in the geographical location of the truck driver device and based on a shipper with at least a predetermined rating information from other truckers.

3. The system of claim 1, comprising code to update a database that includes a load category of interest, a shipper with at least a predetermined rating information from other truckers, and a location of interest.

4. The system of claim 1, comprising code to upload a geographical location of the trucker.

5. The system of claim 1, comprising code to select a trucker or a shipper within a predetermined range of the geographical location having at least a predetermined rating.

6. The system of claim 1, comprising code to decrease the trucker's feedback score if the trucker receives more negatives than positives from one shipper in the same week.

7. The system of claim 1, comprising to code to increase the trucker's feedback score if the trucker receives more positives than negatives from one shipper in the same week.

8. The system of claim 1, comprising If a trucker receives the same number of negatives and positives from the same shipper or broker in the same week, the score is unchanged.

9. The system of claim 1, comprising code to increase a shipper's feedback score for each shipment.

10. The system of claim 1, comprising code to generate a transaction performance score using trucker and shipper rating information.

11. The system of claim 1, comprising code to select a set of questions, to be presented to the first user in order to request the rating information, based on an amount of the performance data retrieved from a rating database.

12. The system of claim 1, comprising code to select a set of questions, to be presented to a user in order to request the rating information, based on transaction data pertaining to the transaction.

13. The system of claim 1, comprising code to select a set of questions, to be presented to the user in order to request the rating information, based on an item type of a subject item of the transaction.

14. The system of claim 1, comprising code to request generic rating information related to the transaction.

15. The system of claim 1, comprising code to request specific rating information related the plurality of performance categories.

16. The system of claim 1, comprising code to collect performance information retrieved from a rating database for each shipping transaction of the plurality of shipping transactions, wherein an associated rating and performance data for each transaction of the plurality of transactions being identified as one of a subjective criteria and an objective criteria; and code to generate a quality score to generate a performance quality score for the shipper using the associated rating and performance information, the performance quality score being lowered if a number of negative ratings associated with the plurality of transactions are below a predetermined threshold.

17. The system of claim 16, including a performance score adjusting code configured to adjust the performance score using the performance quality score.

18. A system, comprising:
a processor-implemented feedback collection module configured to:
match a trucker with a shipper to transport a load in a shipping transaction; and
request rating information from the trucker relating to the shipping transaction, the requested rating information relating to performance of the shipper with respect to the transaction in a plurality of performance categories, wherein the rating information includes timely load availability, load packaging quality, and payment promptness; and
a score generator configured to generate a performance score relating to the shipper using the rating information.

19. The system of claim 18, comprising code to decrease a shipper's feedback score if the shipper receives more negatives than positives from one or more truckers in the same week and to increase a shipper's feedback score if the trucker receives more positives than negatives from one shipper in the same week.

20. A method for shipping items, comprising:
matching a shipper with a trucker to transport a load in a shipping transaction;
collecting rating information from the shipper and the trucker relating to the shipping transaction, the requested rating information relating to performance of the shipper and trucker with respect to the transaction in a plurality of performance categories, wherein the rating information includes shipping quality, shipping cost, timely arrival, condition of delivered items, payment promptness; and
deriving a performance score relating to the trucker using the rating information.
